(19) United States
(12) Patent Application Publication
(10) Pub. No.: US 2023/0416001 A1
(43) Pub. Date: Dec. 28, 2023

(54) LIFTING DEVICES

(71) Applicant: Robert Flaten, Meridian, ID (US)

(72) Inventor: Robert Flaten, Meridian, ID (US)

(21) Appl. No.: 18/215,563

(22) Filed: Jun. 28, 2023

Related U.S. Application Data
(60) Provisional application No. 63/356,403, filed on Jun. 28, 2022.

(51) Int. Cl. B65G 7/12

(52) U.S. Cl. CPC B65G 7/12

(57) ABSTRACT

Described herein generally are lifting devices used to move furniture, mattresses, appliances, bulky items, etc., and the like. The lifting devices can comprise an elongated cord in the shape of a circular loop, and a handle.

### CROSS-REFERENCE TO RELATED APPLICATION

This application claims priority to U.S. Provisional Patent Application Ser. No. 63/356,403, filed Jun. 28, 2022, the contents of which is hereby incorporated by reference in its entirety.

### FIELD

Described herein generally are lifting devices used to move furniture, mattresses, appliances, bulky items, etc., and the like.

### BACKGROUND

In today's fast-paced world, time is everything, especially in the work force. Products currently being used for moving furniture, mattresses, appliances, and the like, take valuable time to be used correctly, e.g., fighting to get proper placement of the strap, untying a seemingly permanent knot, dismantling a cargo device or very literally stepping into a harness. These are methods of the past. The lifting devices described herein allow for a quick and easy process to simply walk up and hook the loop of the lifting device(s) around, over or under the object needing to be moved. Detaching the lifting devices described herein from an object is equally simple and painless, even in confined areas like the back of a moving trailer.

Typically, professional movers have to main concerns when providing a professional moving service: 1) how to prevent getting hurt, and 2) how to avoid damaging the customer's belongings (e.g. appliances, mattresses, furniture, and the like). One of the most frequent and expensive claims a mover incurs is that of a damaged mattress. Clearly having a clean and comfortable place to sleep at night is extremely important to customers so it is of the upmost importance that damage be avoided. Having the proper equipment is the first step in making sure items stay undamaged and arrive as they should. The lifting devices described herein are the only devices on the market that insure mattresses and box springs do not get dirty or torn when being moved by hand. Further, the methods for using the lifting devices described herein keep the material from ever touching the ground from the time they are taken out of a box or plastic cover until they are safely being placed in the house and on an assembled bed frame. Current products on the market simply do not match up as they all require the mattress or box spring first be placed on the ground or on another potentially hazardous surface in order to place the hump strap.

Moving heavy and/or awkward items can be very dangerous. The lifting devices described herein take much of the unnecessary danger out of the equation, and make moving such items not only possible but easy to do. One of the biggest hurtles faced when moving is how to safely move large and unstable mattresses, especially the King and California King mattresses. Traditional hump straps fray and fall apart over time, and are also very difficult to place correctly because they often slip out of position. Losing hold on such an item not only puts the user at risk but frequently results in damage to the piece being carried. Even after eventually getting them placed correctly, they leave the user in an unnatural position that puts ones back in danger of injury. An individual using the lifting devices described herein, can use one hand to comfortably grasp the padded handle, and the other hand to balance the piece being carried/moved. This allows the user to choose any body position necessary for the task at hand, for example, but not limited to, standing upright to keep items off the ground, crouching to avoid low hanging objects like ceilings or lights, and turning tight corners. These positions are all safe and easy using the lifting devices described herein, and positions that a user can easily assume while using the lifting devices described herein.

Many hump straps currently on the market are very uncomfortable to use often resulting in injury and a waste of time. They can leave imprinted hands as a result of constricting material, and it many cases cause a loss of circulation which can be especially problematic when trying to carry heavy and often expensive items. The lifting devices described herein allow the user to hold the lifting device by a padded handle in their palm for ease of comfort.

The lifting devices described herein are simpler to use and provide more versatility, more efficiency, more comfortability, protection against damage, and are safer as will be described below in the detailed description section.

### BRIEF DESCRIPTION OF THE DRAWINGS

FIG. 1 illustrates two individuals each using a lifting device described herein to move a mattress.

FIG. 2 illustrates two individuals each using a lifting device described herein to move a mattress.

FIG. 3 illustrates two individuals each using a lifting device described herein to move a mattress.

FIG. 4 illustrates two individuals each using a lifting device described herein to move furniture.

FIG. 5 illustrates two individuals each using a lifting device described herein to move furniture.

FIG. 6 illustrates a perspective view of a lifting device described herein.

FIG. 7 illustrates a front view of the lifting device illustrated in FIG. 6.

FIG. 8 illustrates a back view of the lifting device illustrated in FIG. 6.

FIG. 9 illustrates a first side view of the lifting device illustrated in FIG. 6.

FIG. 10 illustrates a second side view of the lifting device illustrated in FIG. 6.

FIG. 11 illustrates a top view of the lifting device illustrated in FIG. 6.

FIG. 12 illustrates a bottom view of the lifting device illustrated in FIG. 6.

FIG. 13 illustrates a perspective view of a lifting device described herein.

FIG. 14 illustrates a front view of the lifting device illustrated in FIG. 13.

FIG. 15 illustrates a back view of the lifting device illustrated in FIG. 13.

FIG. 16 illustrates a first side view of the lifting device illustrated in FIG. 13.

FIG. 17 illustrates a second side view of the lifting device illustrated in FIG. 13.

FIG. 18 illustrates a top view of the lifting device illustrated in FIG. 13.

FIG. 19 illustrates a bottom view of the lifting device illustrated in FIG. 13.

FIG. 20 illustrates a perspective view of a lifting device described herein.

FIG. 21 illustrates a front view of the lifting device illustrated in FIG. 20.

FIG. 22 illustrates a back view of the lifting device illustrated in FIG. 20.

### DETAILED DESCRIPTION

Described herein are lifting devices that can be used move furniture, mattresses, appliances, bulky items, etc., and the like. In some embodiments, a lifting device comprises an elongated cord and a handle. The elongated cord can form a loop. The loop can resemble a circular looking hook. The loop can be roundish in shape, coil shaped, circular, oval shaped, and/or resemble the end of a cowboy's lasso.

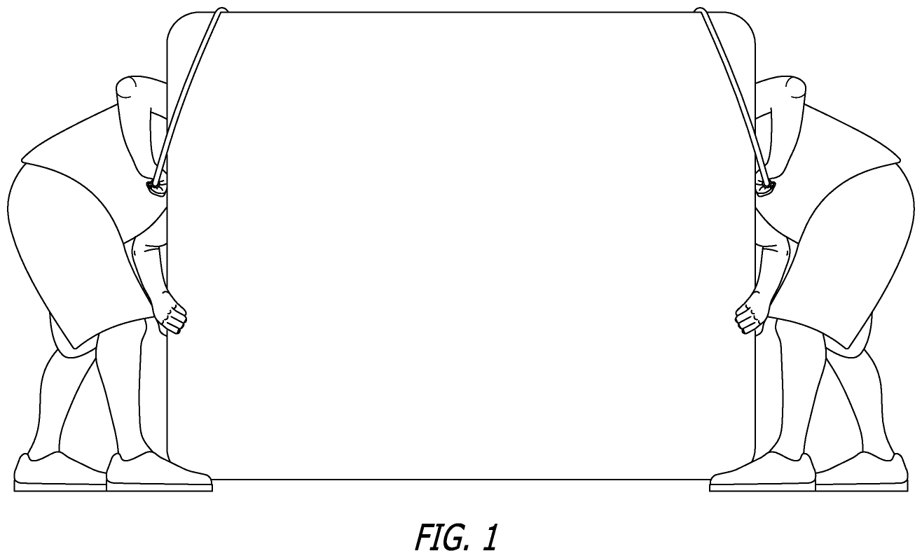

In some embodiments, the lifting devices comprise an elongated cord and a handle. The elongated cord can take the shape of a loop. The elongated cord can have to free ends. One free end of the elongated cord can be joined, bonded, or fastened to the opposing free end of the elongated cord to form a loop or circular looking hook. The free ends of the elongated cord can be joined together by one or more fasteners, adhesives, or the like. In some embodiments, the free ends of the elongated cord are coated with liquid latex. The liquid latex can assist in preventing fraying of the free ends. In one embodiment, as illustrated in FIG. 1, lifting device 100 comprises elongated cord 102 in the shape of a circular loop and handle 104.

Suitable fasteners and/or adhesives include, but are not limited to, epoxy adhesives, polymer-based adhesives, polyurethane adhesives, polyimide adhesives, paste, glue, liquid, film, pellets, holt melt, epoxy glue, rubber-based adhesive, tape, duct tape, zip ties, and/or the like. The fasteners can be pressure sensitive and/or temperature sensitive.

The elongated cord can be made of any material such as, but not limited to, rope, paracord, bungee cord, and/or the like. The paracord can be Type I paracord which holds up to 95 pounds (lbs) and has one core strand, Type II paracord which holds up to 400 lbs and has 4-7 core strands, Type III paracord which holds up to 550 lbs and has 7-9 core strands, or Type IV paracord which holds up to 750 lbs and has 11 core strands. The paracord used can be color coded to signify its type, and therefore the capacity of pounds it can withstand.

In other embodiments, the elongated cord can be composed of one-half (½) inch double braided nylon rope with a breaking load of 7,800 pounds. In some embodiments, the elongated cord can be composed of five-eighths (⅝) inch double braided nylon rope with a breaking load of 12,200 pounds.

The lifting devices described herein can come in different sizes. In some embodiments, the lifting devices come in different sizes, and are color-coded. Color-coding can make it faster and more effective to choose the right lifting device for the job. The lifting devices can be color coded with various colors, such as, but not limited to, red, blue, green, white, orange, and purple. In some embodiments, the color-coding is indicative of the size of the lifting device. In some embodiments, lifting devices can be red, blue, green and white which designate size and is a familiar sight to anyone in the moving industry as it matches rubber band color to size appropriately.

In some embodiments, the circumference of a lifting device color coded white can be about 50 inches, about 51 inches, about 52 inches, about 53 inches, about 54 inches, about inches, about 56 inches, about 57 inches, about 58 inches, about 59 inches, about 60 inches, 50 inches, 51 inches, 52 inches, 53 inches, 54 inches, 55 inches, 56 inches, 57 inches, 58 inches, 59 inches, 60 inches, between about 40 inches and about 50 inches, between about 60 inches and about 60 inches, between about 52 inches and about 56 inches. In one embodiment, the circumference of a lifting device color coded white is 54 inches.

In some embodiments, the circumference of a lifting device color coded green can be about 60 inches, about 61 inches, about 62 inches, about 63 inches, about 64 inches, about 65 inches, about 66 inches, about 67 inches, about 68 inches, about 69 inches, 60 inches, 61 inches, 62 inches, 63 inches, 64 inches, 65 inches, 66 inches, 67 inches, 68 inches, 69 inches, between about 55 inches and about 65 inches, between about 60 inches and about 64 inches. In one embodiment, the circumference of a lifting device color coded green is 62 inches.

In some embodiments, the circumference of a lifting device color coded blue can be about 69 inches, about 70 inches, about 71 inches, about 72 inches, about 73 inches, about 74 69 inches, about 75 inches, about 76 inches, about 77 inches, about 78 inches, about 79 inches, 69 inches, 70 inches, 71 inches, 72 inches, 73 inches, 74 inches, 75 inches, 76 inches, 77 inches, 78 inches, 79 inches, between about 69 inches and about 79 inches, between about 68 inches and about 71 inches. In one embodiment, the circumference of a lifting device color coded blue is 70 inches.

In some embodiments, the circumference of a lifting device color coded red can be about 80 inches, about 81 inches, about 82 inches, about 83 inches, about 84 inches, about 85 inches, about 86 inches, about 87 inches, about 88 inches, about 89 inches, about 90 inches, 80 inches, 81 inches, 82 inches, 83 inches, 84 inches, 85 inches, 86 inches, 87 inches, 88 inches, 89 inches, 90 inches, between about 80 inches and about 90 inches, between about 80 inches and about 84 inches. In one embodiment, the circumference of a lifting device color coded red is 80 inches.

In some embodiments, the two free ends of the elongated cord can be joined by a suitable fastener as described herein to form a loop or circular looking hook. Then a handle can be placed over the joined area of the elongated cord or anywhere on the loop formed by the elongated cord. The handle can be padded. In some embodiments, the padding can be composed of insulation foam or the like.

In other embodiments, one free end of an elongated cord is joined to the opposing free end of the elongated cord by a connector. The connector can be a handle. Each free end of the elongated cord is connected to the handle opposed to each other. The free ends of the elongated cord can be connected to the handle by any fastener, bonding, or adhesive including the fasteners/adhesives described herein.

The handle can be composed of foam. It can be about 5 inches, about 6 inches, about 7 inches, about 8 inches, about 9 inches, about 10 inches, about 11 inches, about 12 inches, 5 inches, 6 inches, 7 inches, 8 inches, 9 inches, 10 inches, 11 inches, 12 inches, between about 5 inches and about 8 inches, between about 8 inches and about 12 inches, or 6 between about 8 inches to about 10 inches in length. The handle can be about 5 inches, about 6 inches, about 7 inches, or between about 5 inches to about 7 inches in circumference. In one embodiment, the handle is 10 inches. The handle can include an anti-slip spray coating. In some embodiments, the handle can include a texturized surface for grip.

In some embodiments, the lifting device further comprises a jacket, which can be composed of different material than the elongated cord. In some embodiments, the jacket is not of a different material than the elongated cord. The jacket can cover a substantial portion of the elongated cord. In other embodiments, the jacket can cover only a portion of the elongated cord. In some embodiments, the jacket can be composed of any material suitable to protect the elongated cord against the elements, and increase the life of the lifting device and its durability. The jacket can add increased rigidity to the elongated cord. The jacket be can be composed of latex, surgical tubing, latex hose, liquid latex that would harden after being dried, or the like, and/or a combination of these materials. The jacket can cover a partial portion of the elongated cord and be located opposite the handle.

In some embodiments, the jacket can cover a portion of the elongated cord and be adjacent to the handle. In other embodiments, the jacket can cover the entire elongated cord that is not covered by the handle. The jacket can cover the entire elongated rope but for the handle. The jacket can include properties or materials to protect the lifting device and allow for a longer life span, and to allow for the lifting device to be used around certain items which may otherwise be damaged in not protected. For example, in some embodiments, a lifting device further comprising a jacket can be used to protect flooring while moving an item. In one embodiment, as illustrated in FIG. 14, lifting device 200 comprises elongated cord 202 in the shape of a circular loop, handle 204, and jacket 206. As illustrated in FIG. 14, jacket 206 is located opposite handle 204 on elongated cord 202 in the shape of a circular loop.

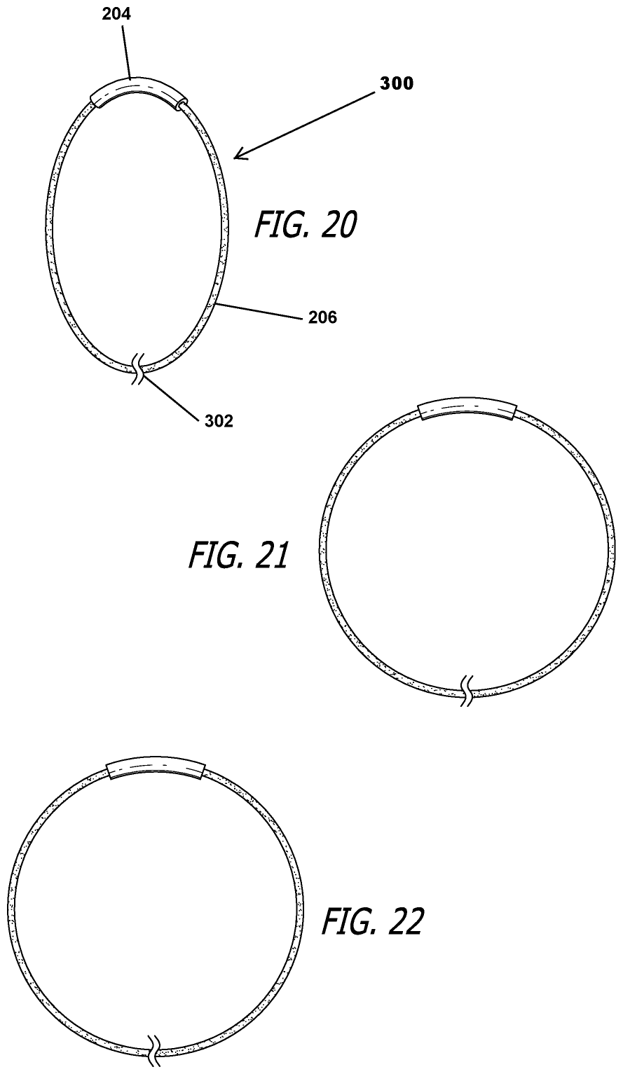

FIGS. 20-22 illustrate an embodiment where the jacket can cover the entire elongated rope but for the handle. As illustrated in FIG. 20, lifting device 300 can comprise jacket 206, which covers the entire elongated rope except for padded handle 204. Wavy lines 302 signify that the jacket can cover any length of the elongated rope. FIGS. 20-22 illustrate the length to be all of the elongated rope but for the padded handle.

In some embodiments a jacket is not used, rather the elongated cord itself can be composed of any material suitable to protect the elongated cord against the elements, and increase the life of the lifting device and its durability. The elongated cord itself can be composed of latex, surgical tubing, latex hose, liquid latex that would harden after being dried, or the like, and/or a combination of these materials.

The lifting device can lift at least 25 pounds (lbs), at least 50 lbs, at least 75 lbs, at least 100 lbs, at least 125 lbs, at least 150 lbs, at least 175 lbs, at least 200 lbs, at least 225 lbs, at least 250 lbs, at least 275 lbs, at least 300 lbs, 25 lbs, 50 lbs, 75 lbs, 100 lbs, 125 lbs, 150 lbs, 175 lbs, 200 lbs, 225 lbs, 250 lbs, 275 lbs, 300 lbs, between about 1 lb and about 200 lbs, between about 100 lbs and about 200 lbs, or between about 200 lbs and about 300 lbs. In one embodiment, the lifting device lifts at least 200 lbs.

The lifting devices described herein can be used to lift various items such as, but not limited to, barbecues, dressers, desks, mechanical bed frames, armoires, small trailers, furniture, appliances, and the like. Virtually any item with legs can be moved safely and effectively using the lifting devices described herein.

Described herein are also methods of using the lifting devices described herein to move furniture, mattresses, appliances, bulky items, etc., and the like. A method of using a lifting device, described herein, to move an item comprises, hooking the lifting device onto the item, grasping the lifting device by a padded handle to lift and move the item.

A person using the lifting device can hook the lifting device to the item to be moved. The person can then use one hand to grasp the handle of the lifting device, and the other hand to balance the item being moved. The lifting device can easily be hooked to any portion of any item, for example, but not limited to, the corner of a mattress, the leg of a table, a wheel of a barbecue, etc. The lifting device can be hooked around, over or under the object needing to be moved. The lifting device can be hooked in any way needed to move the object or furniture. For example, one or more lifting devices can be hooked onto one or wheels of an object or one or more legs of a furniture piece. Also, individuals can use more than one lifting device to move the desired object or furniture. In some cases the person does not need to place the item being moved on the floor prior to hooking the lifting device. The lifting device can be hooked onto the item to be moved without it ever touching the floor. A person can use the lifting device with a Hook-N-Flip method on box springs, mattresses or other similar shaped objects. This method is further exemplified by Example 1 discussed below, and illustrated in FIGS. 1-3. Other lifting devices tend to slip out of position at exactly the wrong moment. The lifting devices described herein once placed do not move out of position until they are intentionally released from the item. The lifting devices are also compact and allow for easy storage. While not in use the lifting devices can easily be hung out of the way, but always ready for convenient use.

In some embodiments, a lifting device is described comprising an elongated cord comprising two free ends; and a handle; wherein the two free ends of the elongated cord are joined via a fastener to form a circular loop, and the handle covers a portion of the elongated cord. The fastener is an adhesive. The two free ends of the elongated cord are coated with liquid latex prior to being joined to prevent fraying. The elongated cord is composed of one-half (½) inch double braided nylon rope or five-eighths (⅝) inch double braided nylon rope. The handle covers the portion of the elongated cord where the joining of the two free ends of the elongated cord occurs. For example, the handle covers the joined portion of the two free ends of the elongated cord. The handle is 10 inches and composed of foam. The lifting device is 54 inches in circumference, 62 inches in circumference, 70 inches in circumference, or 80 inches in circumference. The elongated cord is color-coded, wherein the color-coding is white, green blue, or red. The lifting device further comprises a jacket. The jacket covers the entire elongated cord except for the handle or the jacket covers a portion of the elongated cord that is opposite the handle.

In some embodiments, a method of using a lifting device to move an item comprises hooking the lifting device onto the item; grasping the lifting device by a padded handle to lift and move the item. The lifting device comprises an elongated cord comprising two free ends; and the padded handle; wherein the two free ends of the elongated cord are joined via a fastener to form a circular loop, and the padded handle covers a portion of the elongated cord.

### Example 1: Moving a Mattress

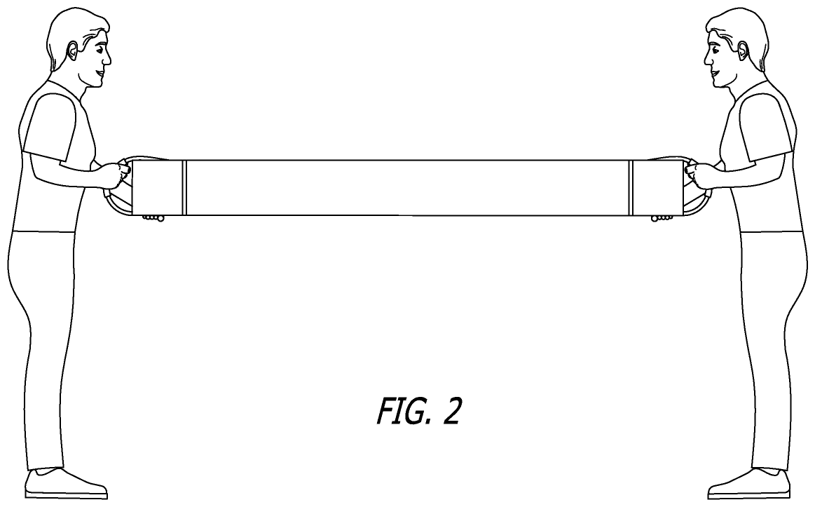

As illustrated, in FIGS. 1-3, the lifting devices are used to move a mattress from one location to another. As illustrated in FIG. 1, two people are on opposing ends of a mattress each equipped with a lifting device. Each person hooks the loop of their respective lifting device onto the top corner of the mattress on their respective side. Each person uses one hand to grasp the padded handle of their lifting device, and the other hand to hold onto/balance the mattress. The two people can then employ the Hook-N-Flip method of the lifting devices, wherein once the hooks of the lifting devices have been placed onto the mattress, the two people can then flip the mattress comfortably to allow for an easier carrying/moving position of the mattresses as illustrated in FIG. 3. FIG. 2 shows the position of the mattress in between the flip when employing the Hook-N-Flip method. The two people are in a more comfortable position and still have the ease of using one hand to grasp the handle of the lifting device and the other hand to balance/position the mattress as needed. The two people can then carry/move the mattress to the desired location. The art of hooking the lifting device and flipping the mattress can be used on similar items.

### Example 2: Moving a Barbecue

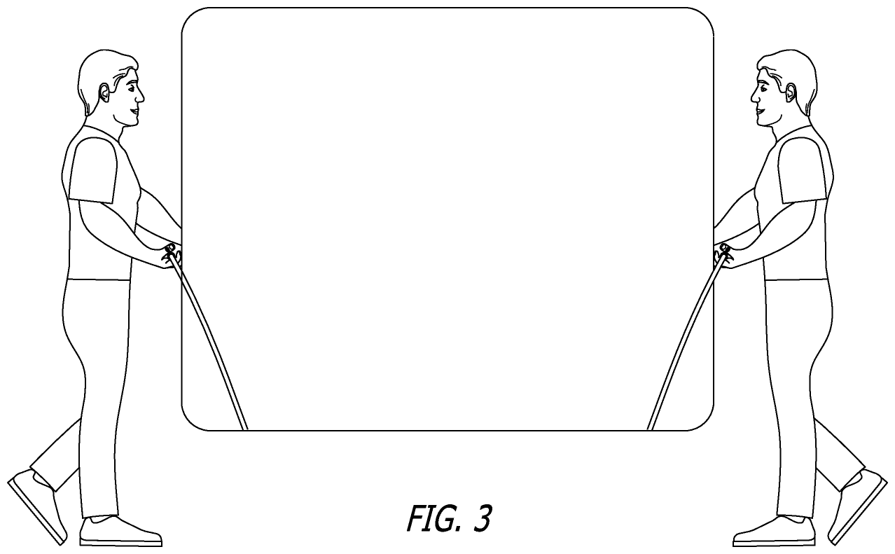

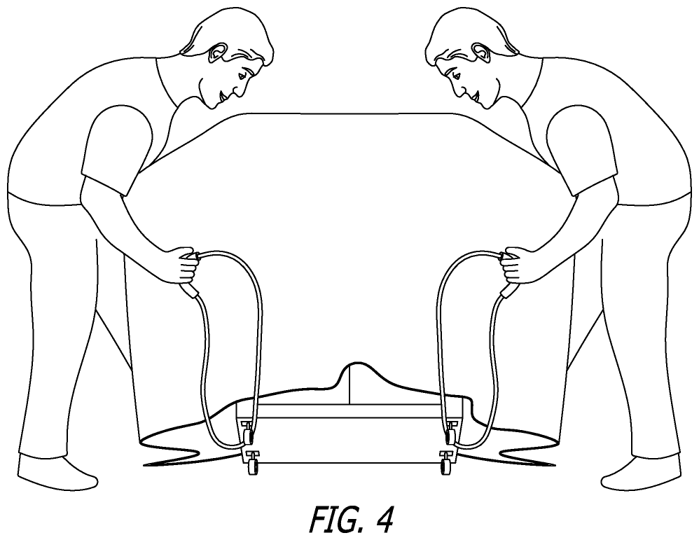

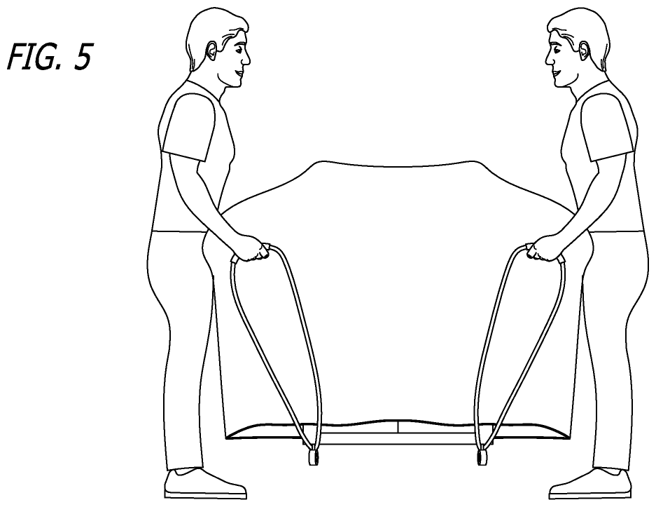

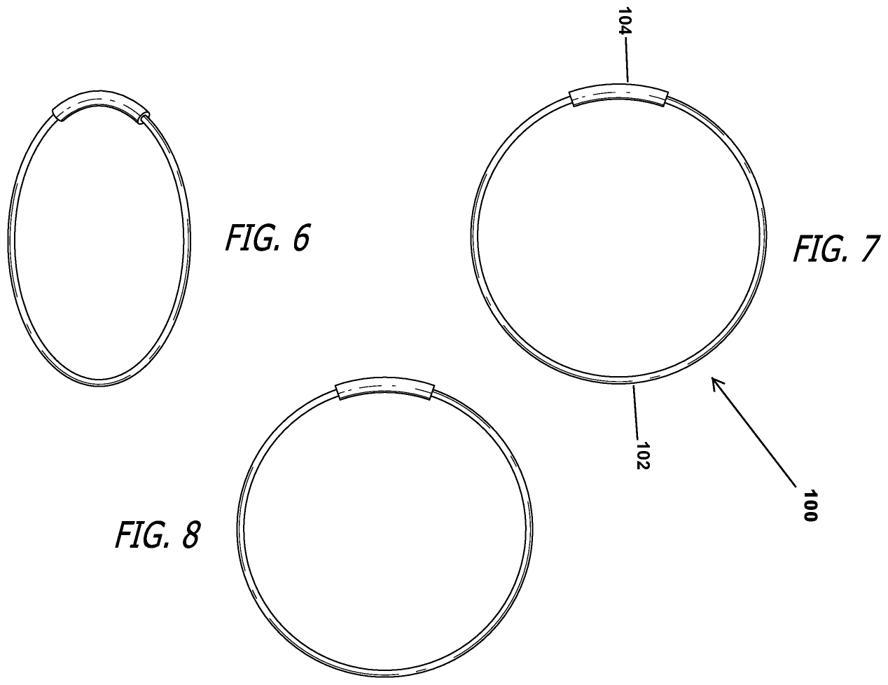

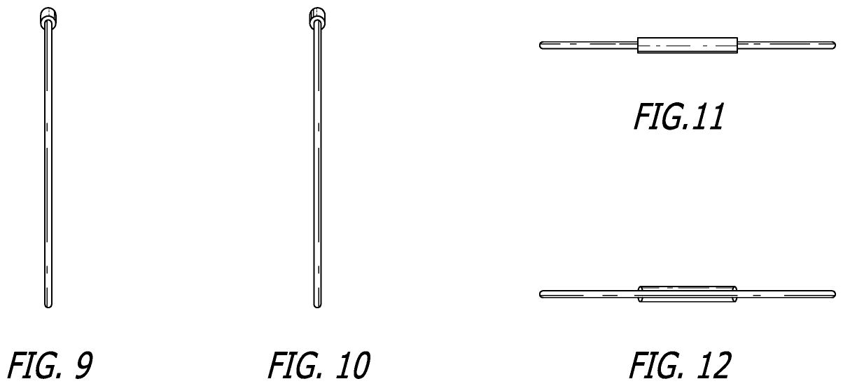

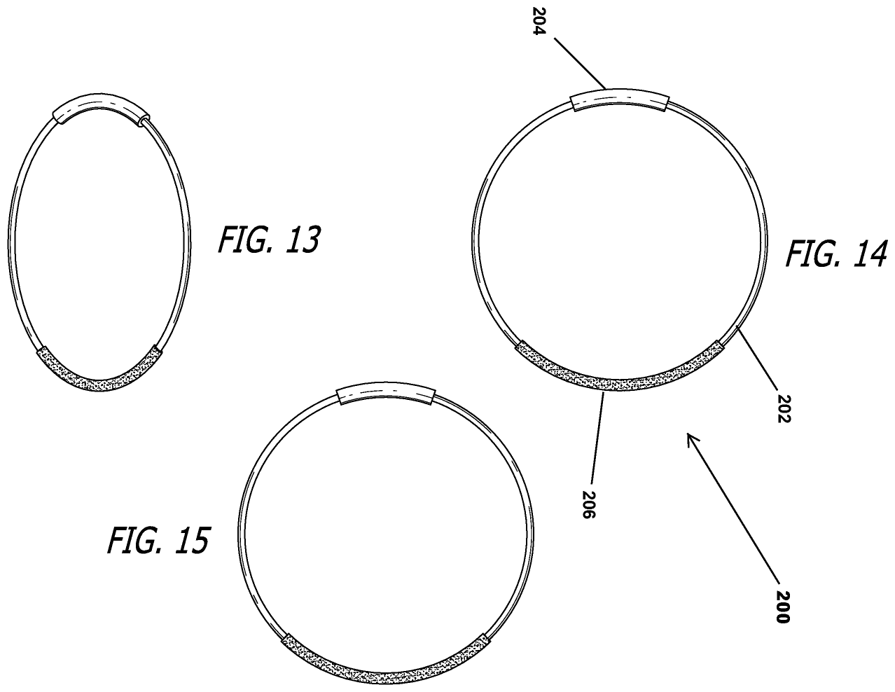

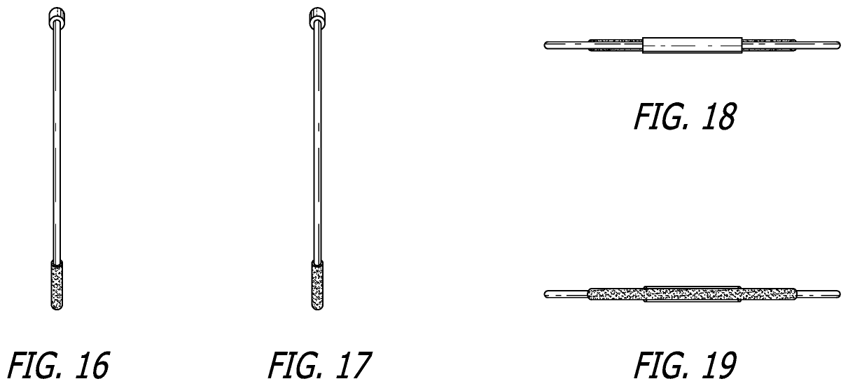

As illustrated in FIGS. 4-5, the lifting devices are used to move a barbecue. A barbecue can present movers with the challenge of how to safely and securely get ahold of the piece without compromising the shelves that protrude off the side. With proper technique the lifting devices can easily and quickly be attached around the legs of the barbecue to give the user a comfortable and stable grip without putting too much pressure on weak areas causing damage to the barbecue. FIG. 4 illustrates two users using this technique. The two users tilt the barbeque to each hook their respective lifting device onto one leg/wheel of the barbecue on their respective side. Each person uses one hand to grasp the padded handle of their lifting device, and the other hand to balance the barbeque. The users are then able to effectively and safely move the barbeque with ease as illustrated in FIG. 5. The two people can then carry/move the mattress to the desired location.

Depending on the size of the barbeque, each respective lifting device can be hooked onto more than one leg/wheel. Also, depending on the size of the barbeque each user can use more than one lifting device to move the barbeque, or alternatively additional users with respective lifting devices could assist in moving the barbeque.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

The terms “a,” “an,” “the” and similar referents used in the context of describing the invention (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments of this invention are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

In closing, it is to be understood that the embodiments of the invention disclosed herein are illustrative of the principles of the present invention. Other modifications that may be employed are within the scope of the invention. Thus, by way of example, but not of limitation, alternative configurations of the present invention may be utilized in accordance with the teachings herein. Accordingly, the present invention is not limited to that precisely as shown and described.

I claim:

1. A lifting device comprising:
an elongated cord comprising two free ends; and
a handle;
wherein the two free ends of the elongated cord are joined via a fastener to form a circular loop, and the handle covers a portion of the elongated cord.

2. The lifting device of claim 1, wherein the fastener is an adhesive.

3. The lifting device of claim 1, wherein the two free ends of the elongated cord are coated with liquid latex prior to being joined to prevent fraying.

4. The lifting device of claim 1, wherein the elongated cord is composed of one-half (½) inch double braided nylon rope.

5. The lifting device of claim 1, wherein the elongated cord is composed of five-eighths (⅝) inch double braided nylon rope.

6. The lifting device of claim 1, wherein the handle covers the portion of the elongated cord where joining of the two free ends of the elongated cord occurs.

7. The lifting device of claim 1, wherein the handle is 10 inches and composed of foam.

8. The lifting device of claim 1, wherein the lifting device is 54 inches in circumference.

9. The lifting device of claim 1, wherein the lifting device is 62 inches in circumference.

10. The lifting device of claim 1, wherein the lifting deice is 70 inches in circumference.

11. The lifting device of claim 1, wherein the lifting device is 80 inches in circumference.

12. The lifting device of claim 1, wherein the elongated cord is color-coded.

13. The lifting device of claim 12, wherein the color-coding is white, green blue, or red.

14. The lifting device of claim 1, further comprising a jacket.

15. The lifting device of claim 14, wherein the jacket covers the entire elongated cord except for the handle.

16. The lifting device of claim 14, wherein the jacket covers a portion of the elongated cord that is opposite the handle.

17. A method of using a lifting device to move an item, the method comprising:
hooking the lifting device onto the item;
grasping the lifting device by a padded handle to lift and move the item.

18. The method of claim 17, wherein the lifting device comprises
an elongated cord comprising two free ends; and
the padded handle;
wherein the two free ends of the elongated cord are joined via a fastener to form a circular loop, and the padded handle covers a portion of the elongated cord.
